(19) United States
(12) Patent Application Publication
(10) Pub. No.: US 2025/0108499 A1
(43) Pub. Date: Apr. 3, 2025

(54) MODULAR TOOL CONTAINER

(71) Applicant: MILWAUKEE ELECTRIC TOOL CORPORATION, Brookfield, WI (US)

(72) Inventor: Peter R. Heath, Wauwatosa, WI (US)

(21) Appl. No.: 18/725,400

(22) PCT Filed: Jan. 4, 2023
(86) PCT No.: PCT/US2023/010079

§ 371 Date: Jun. 28, 2024

Related U.S. Application Data
(60) Provisional application No. 63/296,923, filed on Jan. 6, 2022.

(51) Int. Cl. B25H 3/02

(52) U.S. Cl. CPC B25H 3/02

(57) ABSTRACT

A container includes a base including base walls and a cavity defined by the base walls, a lid movably coupled to the base to selectively enclose the cavity, a first engagement member coupled to one of the base walls, and a hinge rotatably coupled to the base and to the lid adjacent the one of the base walls. The hinge includes a second engagement member that selectively engages the first engagement member. The hinge is held stationary relative the base when the first engagement member engages the second engagement member, and the hinge is movable relative the base when the first engagement member disengages the second engagement member.

### CROSS-REFERENCE TO RELATED APPLICATION

This application claims priority to U.S. Provisional Patent Application No. 63/296,923 filed Jan. 6, 2022, the entire contents of which are incorporated herein by reference.

### FIELD

The present disclosure relates to a tool container or case, and more specifically, to a tool container or case with modular components allowing for user customization.

### SUMMARY

In one aspect, a container includes a base including base walls and a cavity defined by the base walls, a lid movably coupled to the base to selectively enclose the cavity, a first engagement member coupled to one of the base walls, and a hinge rotatably coupled to the base and to the lid adjacent the one of the base walls. The hinge includes a second engagement member that selectively engages the first engagement member. The hinge is held stationary relative the base when the first engagement member engages the second engagement member. The hinge is movable relative the base when the first engagement member disengages the second engagement member.

In another aspect, a container includes a base including base walls and a cavity defined by the base walls, a lid movably coupled to the base to selectively enclose the cavity, and a hinge including a generally planar body having a first end rotatably coupled to the base and a second end rotatable coupled to the lid. The hinge further includes a strengthening rib positioned on the generally planar body between the first end and the second end.

In another aspect, a container includes a base including base walls, a cavity defined by the base walls, and a lip extending from one of the base walls, and a lid including lid walls and a recess formed in one of the lid walls. The lid is movably coupled to the base between an open position and a closed position to selectively enclose the cavity. The lip is received by the recess when the lid is in the closed position to inhibit shifting of the lid relative to the base.

Other aspects of the disclosure will become apparent by consideration of the detailed description and accompanying drawings.

### BRIEF DESCRIPTION OF THE DRAWINGS

FIG. 1 is a perspective view of a tool container.

FIG. 2 is an exploded view of the tool container of FIG. 1.

FIG. 3 is a side view of the tool container of FIG. 1, with a lid in a closed position and the hinge in an engaged position.

FIG. 4 is a top view of the tool container of FIG. 1, with the lid in the closed position and the hinge hidden.

FIG. 5 is a rear view of the tool container of FIG. 1, with the lid in the closed position and the hinge in the engaged position.

FIG. 6 is a front view of the tool container of FIG. 1, with the lid in an example intermediate position.

FIG. 7 is a perspective view of the tool container of FIG. 1, with the lid hidden and the hinge in a disengaged position.

FIG. 8 is a cross-sectional view of the tool container of FIG. 1, taken through the hinge, with the hinge in the disengaged position.

FIG. 9A is a cross-sectional view of the tool container of FIG. 1, taken through the hinge, with the hinge in the engaged position.

FIG. 9B is an enlarged view of the callout box in FIG. 9A.

FIG. 10A is side view of the tool container of FIG. 1, with the lid in an example open position and the hinge in the engaged position.

FIG. 10B is side view of the tool container of FIG. 1, with the lid in an example open position and the hinge in the disengaged position.

FIG. 10C is a side view of the tool container of FIG. 1, with the lid positioned beneath a base of the tool container.

FIG. 10D is a side view of the tool container of FIG. 1, illustrating the example hinge and lid positions of FIGS. 10A-10C.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

In general, the present disclosure relates to a container for storing tools. Modular components couple to the container and allow a user to store the tools in a variety of positions within the container. The container also includes a lid that is movable from a first position on top of the container, to a second position underneath the container.

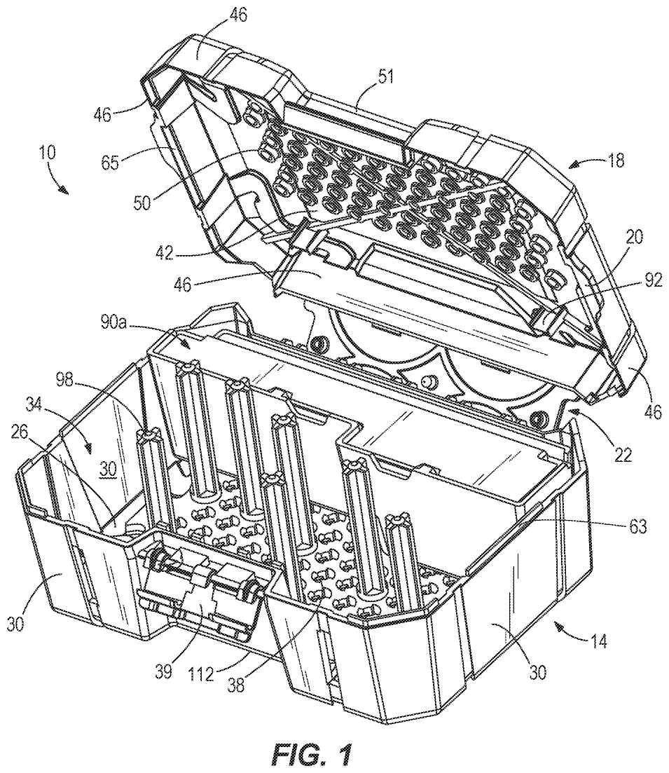

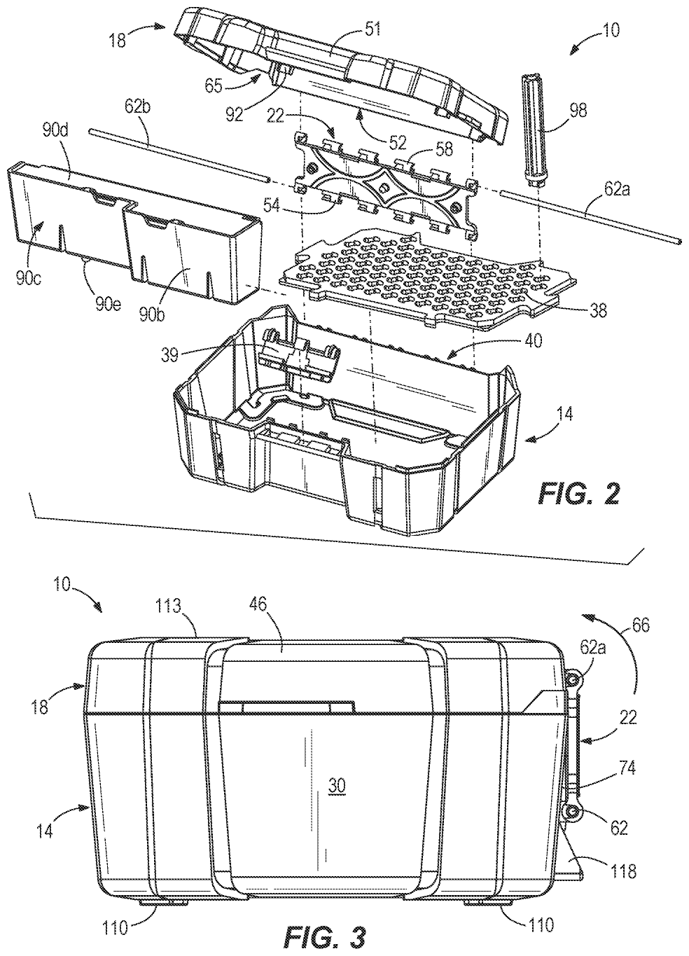

As shown in FIGS. 1 and 2, a tool container or case 10 includes a base 14 coupled to a lid 18 by a hinge 22. The base 14 includes a first or lower surface 26 and walls 30 extending from the lower surface 26 and defining a cavity 34. In some embodiments, a shelf or tab 20 is formed on and/or coupled to at least one of the walls 30 or to the lid 18. In some instances, the tab 20 may provide a handle or grip surface. The case 10 also includes recesses 38 positioned adjacent to the lower surface 26. In the illustrated embodiment, the recesses 38 are formed directly on the lower surfaces 26 and are arranged in rows along the lower surface 26. In the illustrated embodiment, the recesses 38 are sized and shaped to receive a base of an insert 98, peg, and/or the like that is configured to receive a tool (e.g., hole saw blade, oscillating multi-tool (OMT) blade, circular saw blade, etc.). In other embodiments, the recesses 38 may be arranged in other configurations or may be omitted.

Referring still to FIGS. 1 and 2, the lid 18 includes a first or upper surface 42 and walls 46 extending from the upper surface 42. The upper surface 42 includes recesses 50. In the illustrated embodiment, the recesses 50 are circular in shape and have a smaller diameter than the recesses 38. The recesses 50 are also arranged in rows along the upper surface 42. In the illustrated embodiment, when the lid 18 is closed (FIGS. 3-5), the recesses 50 of the lid 18 are substantially aligned with the recesses 38 of the base 14 to receive a tip of the inserts 98. In some embodiments, the recesses 50 also assist in the injection molding process, by eliminating the need for long core pins. In other embodiments, the recesses 50 may be arranged in other configurations or may be omitted.

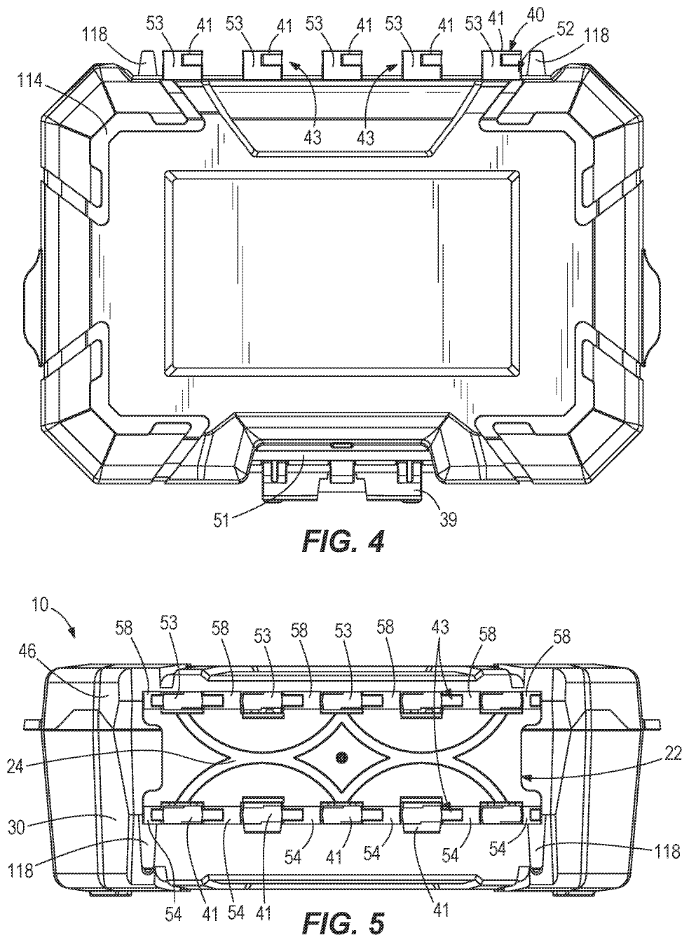

Referring now to FIGS. 1-5, the base 14 also includes a first locking member or latch 39 configured to retain the base 14 and the lid 18 in a closed position (FIG. 3). The base 14 further includes a first receiving portion 40. In the illustrated embodiment, the latch 39 is disposed on one wall 30, and the first receiving portion 40 is disposed on another wall 30 opposite the wall 30 including the latch 39. The latch 39 is movable (e.g., slidable, pivotable, detachable, etc.) relative to the wall 30. As shown in FIGS. 4 and 5, the first receiving portion 40 includes a series of projections 41 separated from each other by a series of openings 43 for coupling to the hinge 22. Centers of the openings 43 are aligned along an axis. The openings 43 provide spaces between adjacent receiving projections 41 that receive portions of the hinge 22 (FIG. 5). In the illustrated embodiment, feet 118 are disposed on either side of the first receiving portion 40. The illustrated feet 118 have triangular profiles. The feet 118 extend outwardly from the wall 30 and may inhibit the base 14 from tipping over.

The lid 18 also includes a second locking member 51 and a second receiving portion 52 (FIG. 2). In the illustrated embodiment, the second locking member 51 is disposed on one wall 46, and the second receiving portion 52 is disposed on an opposite wall 46 from the second locking member 51. The second locking member 51 includes a projection that is fixed relative to the wall 46. The latch 39 selectively engages the second locking member 51 to secure the lid 18 in a closed position. In the illustrated embodiment, the second receiving portion 52 includes a series of projections 53 separated from each other by a series of the openings 43 for coupling to the hinge 22. Centers of the openings 43 are aligned along another axis. In other embodiments, the locking members 39, 51 can be formed on different portions of the case 10.

Before the lid 18 is closed, the latch 39 is moved along the wall 30, providing clearance for the second locking member 51. Once the lid 18 is closed, the latch 39 is moved back along the wall 30 to engage the second locking member 51, thereby securing the lid 18 to the base 14. In some embodiments, the latch 39 may include a biasing member (e.g., a spring) to bias the latch 39 into engagement with the locking member 51. Additionally or alternatively, in some embodiments, the latch 39 may be pivotable relative to the wall 30 to engage and disengage the locking member 51. In further embodiments, other suitable types of latches may be used. In the illustrated embodiment, the lid 18 completely covers the cavity 34 in the closed position. The tabs 20 may facilitate lifting or opening the lid 18 relative to the base 14.

As illustrated in FIGS. 2 and 5, the hinge 22 includes an elongated body. In the illustrated embodiment, the hinge 22 is substantially rectangular in shape. The hinge 22 is also plate-like in that the hinge 22 is relatively thin and generally planar. A third receiving portion 54 is disposed along a first edge of the hinge 22, and a fourth receiving portion 58 is disposed along a second edge of the hinge 22 opposite the first edge. In the illustrated embodiment, the receiving portions 54, 58 include series of aligned openings. Centers of the openings of the third receiving portion 54 and centers of the openings of the fourth receiving portion 58 are each aligned along respective axes.

The first receiving portion 40 of the base 14 is aligned with the third receiving portion 54 of the hinge 22, and the second receiving portion 52 of the lid 18 is aligned with the fourth receiving portion 58 of the hinge 22. With such an arrangement, the centers of the series of openings making up the third and fourth receiving portions 54, 58 are aligned with the centers of the series of openings of the first and second receiving portions 40, 52 respectively. Rods or pins 62 are received in the adjacent receiving portions (e.g., the first and third receiving portions 40, 54 and the second and fourth receiving portions 52, 58). The rods include a first rod 62a that rotatably couples the hinge 22 to the lid 18 and a second rod 62b that rotatably couples the hinge 22 to the base 14. The illustrated first and second rods 62a, 62b are parallel and define pivot axes. In the illustrated embodiment, the hinge 22 includes a rib 24. The rib 24 may strengthen the hinge 22, and may include rigid curves, undulations, and/or the like. In some embodiments, the rib 24 is coupled to the body of the hinge 22, while in other embodiments, the rib 24 and the body are integrally formed together. Other embodiments of the hinge 22 are formed of plastic, polymer, and/or the like, and the rib 24 is molded to/positioned within/extruded from the body of the hinge 22.

As shown in FIG. 3, the lid 18 is movable relative to the base 14 to a first or closed position. The hinge 22 is pivotable relative to the base 14 about the second rod 62b (or second pivot axis), and the lid 18 is pivotable relative to the hinge 22 about the first rod 62a (or first pivot axis). Both the hinge 22 and the lid 18 pivot toward the base 14 in a first rotational direction identified by arrow 66 (e.g., counterclockwise in FIG. 3). In the illustrated embodiment, the hinge 22 is pivotable to a substantially vertical position, and the lid 18 is pivotable to a substantially orthogonal position relative to the hinge 22 when in the closed position.

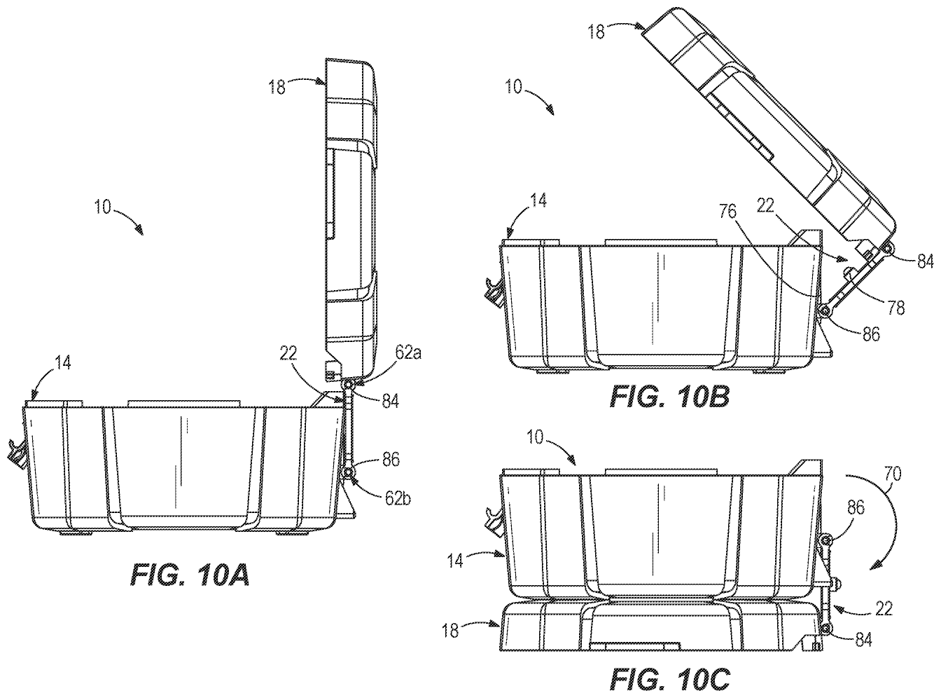

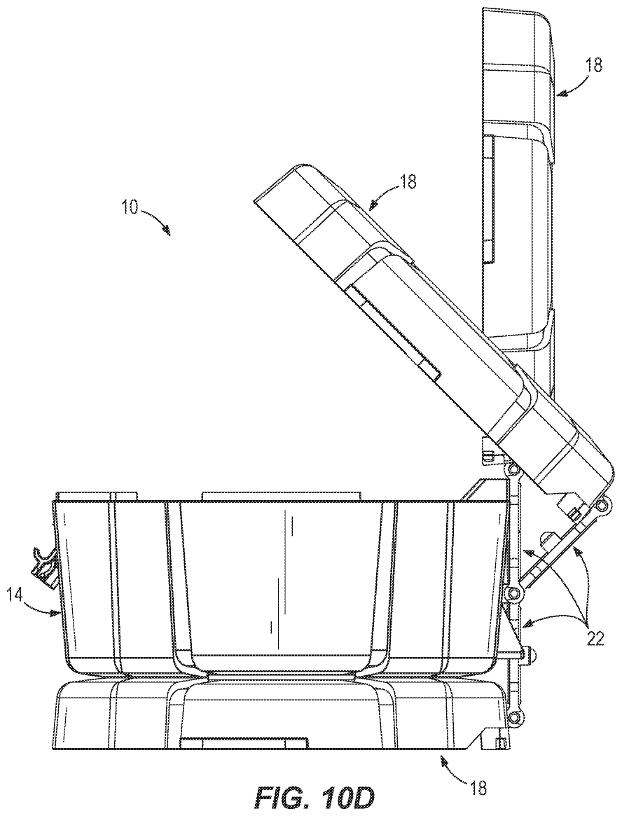

As shown in FIGS. 1-3 of the illustrated embodiment, an outer surface 112 of the base 14 opposite the lower surface 26 includes projections or feet 110 disposed proximate corners of the base 14 (FIG. 3). An outer surface 113 of the lid 18 opposite the upper surface 42 includes complementary depressions 114 (FIG. 4). The feet 110 mate with the depressions 114 when the base 14 rests on top of the lid 18 (FIG. 10C), securing (e.g., via an interference fit) the lid 18 to the base 14 until the two are moved (e.g., pulled) apart by a user. In some embodiments, the feet 110 may fit loosely within the depressions 114 such that the feet 110 and the depressions 114 help align the lid 18 under the base 14, but do not secure the lid 18 under the base 14. Additionally, the feet 110 and the depressions 114 may help stack with the case 10 with similarly sized cases having similar feet and depressions.

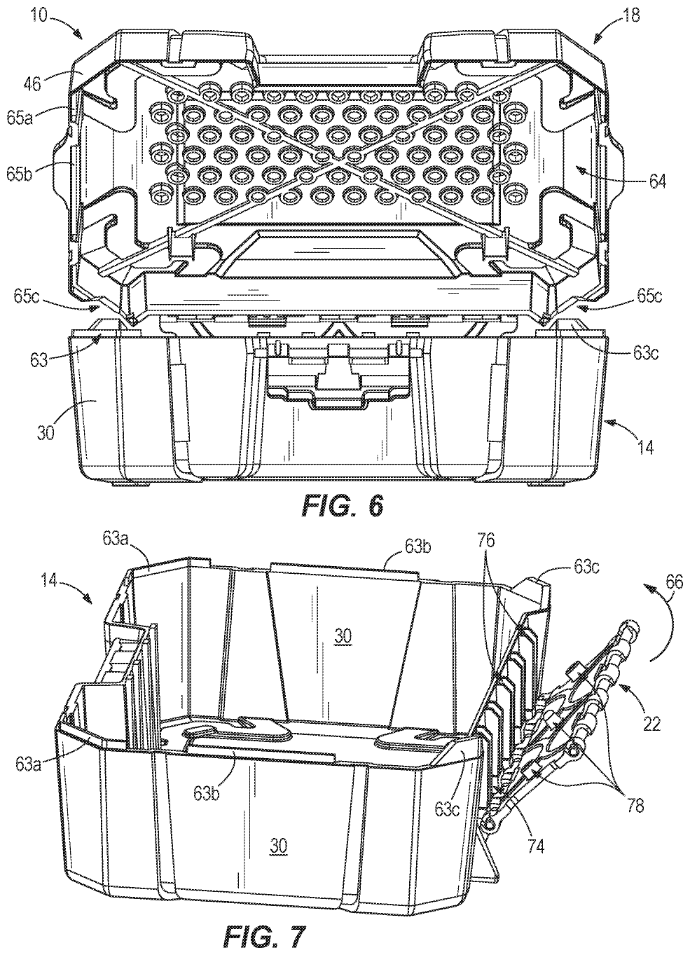

Referring now to FIGS. 6 and 7, the base 14 and lid 18 may each include raised edges, lips, alignment flanges, protrusions, and/or the like. In the illustrated embodiment, the base 14 includes a plurality of protrusions, projections, flanges, or lips 63 that extend upwardly (e.g., toward the lid 18) from an upper edge of the wall 30. Some embodiments of the lid 18 includes a plurality of gaps, slits, notches, or recesses 65, formed in a lower part of the wall 46, that are complementary to the lips 63. In such embodiments, the recesses 65 are sized and shaped to receive the lips 63. In the illustrated embodiment, the recesses 65 communicate with a cavity 64 defined by the lid 18. The lips 63, thereby, extend into the cavity 64 when the lid 18 is closed. In other embodiments, gaps may be formed between inner and outer surfaces of the wall 46. The lip 63 could also be considered as a flange like structure, such as a flange, a flange groove, a lip groove, and/or the like.

In the illustrated embodiment, the lips 63 include a first set of lips 63a formed on a front portion of the base 14, a second set of lips 63b formed on an intermediate portion of the base 14, and a third set of lips 63c formed on a rear portion of the base 14. As shown in FIGS. 1 and 6, the recesses 65 include a first set of recesses 65a, a second set of recesses 65b, and a third set of recesses or notches 65c. The first set of lips 63a are configured to be received by the first set of recesses 65a. The second set of lips 63b may also be referred to as intermediate lips and are configured to be received by the second set of recesses 65b. The third set of lips 63c may also be referred to as wings, and the wings 63c are shaped and positioned to be received by the notches 65c. In some embodiments, the lips 63c and notches 65c may be reversed and/or positioned on either of the lid 18 and the base 14.

As shown in FIG. 7, the first set of lips 63a on the front portions are formed adjacent front corners of the case 10. While the front and rear corners of the illustrated embodiment are generally angled, chamfered, etc., the corners could form a substantially right angle. In some embodiments, the intermediate lips 63b are positioned adjacent the tabs 20. The lips 63 positioned on the wall 30, when extending into the cavity 64, substantially or may even totally inhibit shifting of the base 14 and lid 18 relative one another (e.g., side-to-side, front-to-rear, rotation, etc.). In some embodiments, the first and second set of lips 63a, 63b inhibit relative sliding between the base 14 and the lid 18, and the wings 63c may fit within a slot or cutout in the lid 18 to inhibit torsional or twisting between the base 14 and the lid 18. The wings 63c may also provide further stability to the lid 18 as it is opened. In some embodiments, the wings 63c interlock with portions of the lid 18.

As further illustrated in FIG. 7, the lips 63 may occupy a portion (e.g., width) of an upper surface of the wall 30 of the base 14. In the illustrated embodiment, at least some of the lips 63 (e.g., the first and second set of lips 63a, 63b) occupy an inner portion of the wall 30 and will extend into the cavity 64 (FIG. 6), for example, within a perimeter of the lid 18 (FIG. 6), when the lid 18 is closed to form an interlock between the walls 46 of the lid 18 and the walls 30 of the base 14. In other words, the lips 63 may extend from approximately half of the upper surface of the wall 30 such that an inner surface of the wall 46 engages the lips 63 and a lower surface of the lid wall 46 engages the upper surface of the base wall 30. In other embodiments, the locations of the lips may be reversed, or the walls 30, 46 may include other features for creating an interlock between the walls 30, 46. In the illustrated embodiment, the first and second set of lips 63a, 63b occupy a portion (e.g., width) of an upper surface of the wall 30 and the wings 63c occupy an entire or substantially entire portion (e.g., width) of the upper surface of the wall 30.

Referring now to FIGS. 7-9B, the base 14 includes contact surfaces or receivers 74 extending from one of the walls 30. The hinge 22 pivots in the first rotational direction 66 toward the receivers 74 and may pivot up to contact the receivers 74. In one example application, the receivers 74 prevent the hinge 22 from being acute with respect to the wall 30. In the closed position, the walls 46 of the lid 18 contact the walls 30 of the base 14 and the lips 63. The receivers 74 and the lips 63 are configured to interlock the two sets of walls 30, 46 and help secure the case 10 (e.g., keep the case closed) in the event that the case 10 is dropped, under load, tilted, etc.

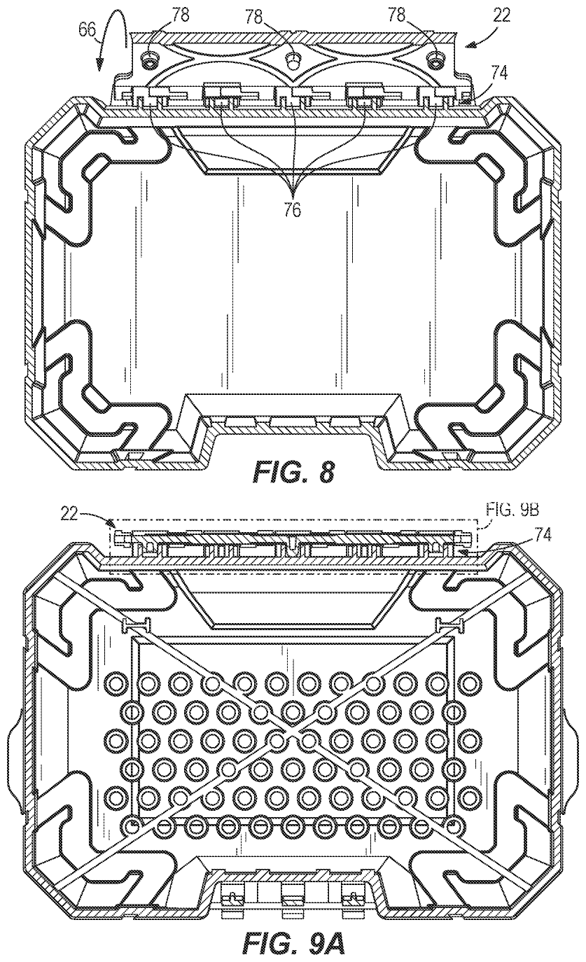

With specific reference to FIGS. 7 and 8, the illustrated receivers 74 include a plurality of detents 76 that may be formed as ridges, cavities, valleys, and/or the like. The detents 76 may also be referred to as first engagement members. The detents 76 may be elastically deformable recesses positioned on the base 14 to receive stoppers or projections 78 on the hinge 22. The projections 78 may also be referred to as second engagement members. The projections 78 may be lugs, pins, balls, and/or the like that may be pressed into or received by the detents 76. For example, the hinge 22 can be rotated in the first rotational direction 66 toward the base 14 to bring the lugs 78 into contact with the detents 76. When pressed into the detents 76, the lugs 78 may inhibit rotation of the hinge 22 relative to (e.g., away from) the base 14, but still allow rotation of the lid 18 relative to the hinge 22 (and thereby the base 14). In some embodiments, the engagement between the detents 76 and the lugs 78 is substantially elastic such that a user can overcome a friction force between the detents 76 and the lugs 78 to separate the lugs 78 from the detents 76. In other embodiments, the hinge 22, base 14, and/or lid 18 may include an actuator that may be operated by a user to separate the lugs 78 from the detents 76.

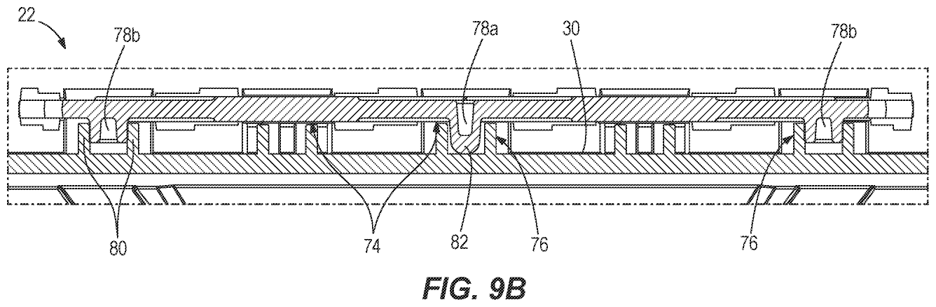

FIG. 9B illustrates a magnified portion of the case 10, namely the callout portion surrounding the hinge 22 shown in FIG. 9A. Accordingly, with reference to FIG. 9B, the lugs 78 include a primary or central lug 78a and a plurality of secondary or side lugs 78b positioned on either side of central lug 78a. In the illustrated embodiment, the central lug 78a has a smaller outer dimension (e.g., diameter) than the side lugs 78b. As such, the central lug 78a fits in the corresponding detent 76, but does not engage inner surfaces of the corresponding receiver 74 to create an interference or friction fit. Rather, the central lug 78a helps reduce hyperextension (e.g., unintended flexing, rotation, or deformation) of the hinge 22. The central lug 78a can help reduce an amount the hinge 22 is allowed to move that could result in misalignment of the lid 18 and base 14 when the lid 18 is in its closed position on the base 14. For example, if the lid 18 and base 14 were misaligned, complimentary or like surfaces of each may not mesh together or fit properly (e.g., when a front end of the lid 18 extends beyond or past a front end of the base 14). In some embodiments, one or more of the lugs 78 includes an additional receptacle configured to receive a protuberance extending from the receivers 74 (e.g., from within the detents 76). In the illustrated embodiment, each detent 76 includes opposing ridges, flanges, or walls 80 that can selectively receive the lugs 78 therebetween. In some embodiments, the walls are formed as a recess having a cylindrical, conical, partially conical, etc. shape that is at least partially complementary to a shape of the lug(s) 78.

As further illustrated in FIG. 9B, the side lugs 78b are each received in corresponding detents 76, between the opposing walls 80, to engage the base 14 (FIG. 7). When the side lugs 78b engage the detents 76, the engagement forms an interference fit to better secure the lid 18 in place. Further, when engaged, the side lugs 78b may engage the detents 76 to resist relative displacement (e.g., rotation, twisting, etc.) between the base 14 and the lid 18.

In the illustrated embodiment, the case 10 includes five receivers 74, at least three of which include detents 76 for receiving the lugs 78. In other embodiments, any number of receivers, detents, and/or lugs may be included depending on, for example, a size, weight, durability, capability, etc. of the case 10. As shown in FIG. 9B, the central lug 78a may include a deformable stopper 82 that abuts or bears against the wall 30 of the base 14. In other embodiments, the stopper may be omitted. In the illustrated embodiment, the detents 76 are receptacles formed on the base 14, and the lugs 78 are formed on the hinge 22. In other embodiments, the positions of the detents 76 and the lugs 78 may be switched or altered. For example, detents 76 could be formed on the hinge 22 and lugs 78 on the base 14. In another example, each of the hinge 22 and base 14 could include alternating lugs 78 and detents 76. In yet another example, each of the hinge 22, lid 18, and/or base 14 could include any arrangement of lugs 78 and detents 76.

In still other embodiments, the case 10 may include other types of first and second engagement members for selectively securing the hinge 22 relative to the base 14. For example, the first engagement members may be magnets and the second engagement members may be metal pieces, or vice versa. Alternatively, the first and second engagement members may be snaps, hooks, hook and loop fasteners (e.g., Velcro), and the like.

Referring now to FIGS. 10A-10D, the lid 18 is further movable relative to the base 14 from the closed position (FIG. 3) to multiple example open positions. The hinge 22 and the lid 18 can each pivot in a second rotational direction identified by arrow 70 (e.g., clockwise in FIG. 10C), which is opposite the first rotational direction 66 (FIG. 3). The lid 18 pivots in the second rotational direction 70 and allows the base 14 to rest on top of the lid 18 (i.e., the lower surface 26 faces in an opposite direction as the upper surface 42). The pivot axis defined by each rod or pin 62 of the hinge 22 may be referred to as a rotational joint. For example, as illustrated in FIG. 10A, the first rod 62a defines a first or upper joint 84 coupling the hinge 22 to the lid 18 and the second rod 62b defines a second or lower joint 86 coupling the hinge 22 to the base 14. In the illustrated embodiment, the lugs 78 and detents 76 are positioned between the joints 84, 86.

FIG. 10A illustrates the lid 18 in an example open position and the hinge 22 in an example secured or engaged position. In this position, the hinge 22 is not rotated relative the base 14, but the lid 18 is rotated relative the hinge 22 and the base 14. The hinge 22 may be held in the example engaged position by the detents 76 and lugs 78 (or other engagement members) such that the lid 18 may be rotated relative the base 14 and hinge 22 about only the upper joint 84. In other words, the detents 76 and lugs 78, when engaged, retain the hinge 22 to the base 14 and stabilize the lid 18 to rotate like a conventional lid 18 (e.g., through approximately 180 degrees of rotation about a single axis).

FIG. 10B illustrates the lid 18 in an example intermediate open position or configuration and the hinge 22 in an example disengaged and a partially rotated position. In this position, the lid 18 is rotated relative the hinge 22 and the base 14, and the hinge 22 is rotated relative the base 14. As illustrated in FIG. 10B, the hinge 22, when the lugs 78 and detents 76 are separated from one another, is allowed to rotate relative the base 14 about the lower joint 86, and the lid 18 is allowed to rotated relative the hinge 22 about the upper joint 84. In operation, a user may overcome the biasing force provided by the lugs 78 and detents 76 to push the hinge 22 away from the base 14 and rotate the hinge 22 relative the base 14. Therefore, the hinge 22 may be selectively operated to provide two-degree movement (e.g., offset rotation) of the lid 18 relative the base 14.

FIG. 10C illustrates the lid 18 in an example fully open position or configuration and the hinge 22 in the disengaged and an example fully rotated position. In this position, the lid 18 is positioned beneath the base 14, and the hinge 22 and lid 18 are rotated by approximately 180 degrees relative the case 10 configuration illustrated in FIG. 3 (e.g., the closed position). The lid 18 and hinge 22 pivot in the second rotational direction 70 and allow the base 14 to rest on top of the lid 18. In the example fully open position, the cavity 34 (FIG. 1) is unobstructed (i.e., the lid 18 and the hinge 22 are not blocking the cavity 34 in any way). While in this position, a user may access the cavity 34 along any of the walls 30. In other situations (FIG. 10A), a user may not need to move the lid 18 to the fully open position, and may pivot the hinge 22 and/or the lid 18 in the second rotational direction 70 so that the lid 18 is spaced apart from the base 14, but that the base 14 does not rest on top of the lid 18. The fully open position, however, is also useful when displaying the case 10 in, for example, a store. The case 10 may be packaged (e.g., in a clear blister pack) while in any of the example configurations/positions.

FIG. 10C illustrates an example range of motion of the lid 18 relative the hinge 22 and of the lid 18 and hinge 22 relative the base 14.

The case 10 may be used to store tools and tool accessories. For example, in the illustrated embodiment, the case 10 may be used to store hole saws and arbors. As shown in FIG. 1, one or more first inserts are positioned within the cavity 34. In the illustrated embodiment, the first inset is an arbor box 90a. As shown in FIG. 3, the arbor box 90a includes a base 90b defining a compartment or cavity 90c, a cover 90d, and posts or pins 90e. The cover 90d is movable (e.g., pivotable) relative to the base 90b and selectively covers the cavity 90c. When the lid 18 is in the closed position (FIG. 3), the cover 90d is unable to open and expose the cavity 90c. The lid 18 also includes two lugs 92 (FIGS. 1 and 2), which engage the cover 90d when the lid 18 is in the closed position. The lugs 92 inhibit the cover 90d from opening in the event the case 10 is dropped. In the illustrated embodiment, the arbor box 90a includes pins that are receivable in any of the recesses 38. A user may reposition the arbor box 90a anywhere within the case 10 by positioning the pins within different recesses. Additional arbor boxes (not shown) may also be positioned within the case 10. The arbor box 90a is configured to store the arbor.

One or more second inserts, such as pegs 98, may positioned within the cavity 34. The pegs 98 may be x- or cross-shaped cross-sections. In other embodiments, the pegs 98 may be frustoconically-shaped and/or have cylindrical-, square-, or the like shaped cross-sections. The pegs 98 may be configured to hold hole saws. For example, the hole saws slide over an end and onto the peg 98. In some scenarios, the pegs 98 are configured to hold one or more hole saws with different diameters in stacked configurations. Moving the pegs 98 to different recesses 38 allows a user to store the hole saws in different configurations within the case 10. The pegs 98 and/or alternate pegs may be secured in the cavity via threads, a bayonet connection, or the like.

The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described. Various features and advantages of the invention are set forth in the following claims.

What is claimed is:

1. A container comprising:
a base including base walls and a cavity defined by the base walls;
a lid movably coupled to the base to selectively enclose the cavity;
a first engagement member coupled to one of the base walls; and
a hinge rotatably coupled to the base and to the lid adjacent the one of the base walls, the hinge including a second engagement member that selectively engages the first engagement member, the hinge being held stationary relative the base when the first engagement member engages the second engagement member, and the hinge being movable relative the base when the first engagement member disengages the second engagement member.

2. The container of claim 1, wherein the lid is movable relative to the base between an open position and a closed position when the first engagement member engages the second engagement member.

3. The container of claim 1, wherein the first engagement member includes a detent, and wherein the second engagement member includes a lug that is selectively received in the detent.

4. The container of claim 1, wherein the first engagement member is one of a plurality of first engagement members, and wherein the second engagement member is one of a plurality of second engagement members.

5. The container of claim 4, wherein the hinge further comprises a central lug, and wherein the plurality of second engagement members includes side lugs.

6. The container of claim 5, wherein the central lug has a smaller outer dimension than the side lugs.

7. The container of claim 5, wherein the central lug includes a deformable stopper configured to abut the one of the base walls.

8. The container of claim 1, wherein the lid is pivotable to a position beneath the base to rest the base on top of the lid when the first engagement member disengages the second engagement member.

9. The container of claim 1, wherein the hinge further comprises a generally planar body and a strengthening rib positioned on the generally planar body.

10. The container of claim 1, wherein the base further comprises a lip, wherein the lid further comprises a recess, and wherein the lip is received by the recess when the lid is in a closed position.

11. A container comprising:
a base including base walls and a cavity defined by the base walls;
a lid movably coupled to the base to selectively enclose the cavity; and
a hinge including a generally planar body having a first end rotatably coupled to the base and a second end rotatably coupled to the lid, the hinge including a strengthening rib positioned on the generally planar body between the first end and the second end.

12. The container of claim 11, wherein the strengthening rib includes rigid curved portions.

13. The container of claim 11, wherein the strengthening rib is integrally formed with the generally planar body.

14. A container comprising:
a base including base walls, a cavity defined by the base walls, and a lip extending from one of the base walls; and
a lid including lid walls and a recess formed in one of the lid walls, the lid movably coupled to the base between an open position and a closed position to selectively enclose the cavity,
wherein the lip is received by the recess when the lid is in the closed position to inhibit shifting of the lid relative to the base.

15. The container of claim 14, wherein the lip is one of a plurality of lips and the recess is one of a plurality of recesses.

16. The container of claim 15, wherein the plurality of lips includes a first lip formed on a front portion of the base, a second lip formed on an intermediate portion of the base, and a third lip formed on a rear portion of the base.

17. The container of claim 14, wherein the lip is positioned on an upper edge of one of the base walls.

18. The container of claim 17, wherein the lip occupies an inner portion of the upper edge.

19. The container of claim 14, wherein the lip interlocks with the lid.

20. The container of claim 14, wherein the lip extends into the lid when the lid is in a closed position.
